(19) United States
(12) Patent Application Publication
(10) Pub. No.: US 2017/0072346 A1
(43) Pub. Date: Mar. 16, 2017

(54) BACK-FLUSHABLE FILTERED VALVE

(71) Applicant: Curtis A. Vancura, San Gabriel, CA (US)

(72) Inventor: Curtis A. Vancura, San Gabriel, CA (US)

(21) Appl. No.: 15/265,610

(22) Filed: Sep. 14, 2016

Related U.S. Application Data
(60) Provisional application No. 62/218,403, filed on Sep. 14, 2015.

(51) Int. Cl. B01D 35/02; E03C 1/02

(52) U.S. Cl. CPC B01D 35/02; E03C 1/02

(57) ABSTRACT

A back-flushable filtered valve including a valve body having an inlet and outlet. The valve includes an inner core disposed within the valve body. The inner core is rotatably coupled to the valve body. The inner core includes an inner core flow path such that when the inner core is turned to a first mode fluid may thereby traverse the valve body. The inner core includes a filter disposed within the inner core flow path that substantially blocks the inner core flow path for particulates greater than the filter sizing. The valve includes a diversion outlet spaced from the valve inlet and the valve outlet and is functionally coupled to the inner core such that when the inner core is turned to a second mode the first side of the filter faces the diversion outlet and fluid backflows therethrough thus cleaning the filter, ejecting particulates out the diversion outlet.

### CROSS-REFERENCE TO RELATED APPLICATIONS

This invention claims priority, under 35 U.S.C. §120, to the U.S. Provisional Patent Application No. 62/218,403 to Curtis A. Vancura filed on Sep. 14, 2015, which is incorporated by reference herein.

### BACKGROUND OF THE INVENTION

Field of the Invention

The present invention relates to valves and systems that use valves therein, specifically a back-flushable filtered valve and/or a system using the same.

Description of the Related Art

Although particulate matter is sometimes an intended byproduct of industrial operations (often called precipitates, and herein the term sediment will refer also to precipitates and similar collectible matter using filtration), more commonly it is what has caused poor performance in many devices by lodging in orifices, valves and other devices for well over 100 years.

There are many compositions and sources of particulate matter, and devices for filtering it are widely known virtually everywhere fluid flows through pipes. There are a multitude of large and complex filtering systems in use, as well as smaller, yet still large and complex filters, and there are simple in-line filters with little complexity, the simplest may perhaps be a simple screen filter insert that may be placed into a shower head, for instance.

One issue with the filters that causes much attention is what to do with a filter that has collected its capacity of particulate matter, and needs cleaning, emptying or replacement. Many filters require removal and disassembly for cleaning, or simply discarded and replaced. For convenience purposes some have taught methods of manufacturing filter assemblies that have a feature for using a valve to clean the filter without removing the filter or the valve from its assembled state.

One method taught is to utilize a design that cross-flushes the filter of particulates, discharging the particulates from the surface of the filter, but many find that this method still leaves imbedded particulates in the filter medium, requiring additional maintenance by the methods described above.

Some improvements have been made in the field. Examples of references related to the present invention are described below in their own words, and the supporting teachings of each reference are incorporated by reference herein:

U.S. Pat. No. 5,997,750, issued to Rozelle et al., discloses a process and apparatus for producing purified drinking water from surface or ground fresh water sources using no chemical pre-treatment or coagulants, by usage of a positively-charged filtration media to attract the typically negatively-charged suspended solids present in the water source. The process, which can be portable, includes a filtration system having a filtration/recirculation/backwash component and a disinfection step. The process further includes a system controller which receives electrical signals from float controls to control the filtration, recirculation, and backwash steps. This process produces drinking water which meets or exceeds the guidelines set by the World Health Organization for turbidity and microbiological content.

U.S. Pat. No. 7,097,122, issued to Farley, discloses a combination shower arm and water filter having an integrated design for attachment between a shower wall and a showerhead. The combination shower arm and water filter includes a housing having a number of components that may be easily manipulated, and which may be connected to any available showerhead, without the need of special tools. The combination shower arm and water filter allows an attached showerhead to be extended, moved or rotated into more accessible positions by actuation of the movable portions.

U.S. Patent Application Publication No.: 2011/0017932, by Matos, discloses a manufacture method of monoblock ball valve is based on overmoulding techniques and integral assembly of plastic components inside the injection moulds, in a sequential manufacturing process, wherein the component which is injected in the first stage of the process will be sequentially introduced in moulds which will in turn inject other components, thus resulting in the end in a single body that ensures the functional features of a piece obtained by several components' assembly. The hydraulic ball valve according to the invention comprises at least the following components: a ball filling element or valve filling core with a valve control stem, —a ball that involves the ball filling element; a sleeve-type sealing element, which covers the entire ball and the whole interior part of the valve body, and a valve body.

U.S. Patent Application Publication No.: 2012/0055888, by Hunter et al., discloses removable and replaceable outlets for point-of-use showers or faucets, filter devices, and methods and systems including the outlets and/or filter devices, are disclosed.

The inventions heretofore known suffer from a number of disadvantages which include being inconvenient, being too large, being too complex, including too many parts, being expensive, not being durable, not being reliable, being difficult and/or expensive to maintain, being difficult to install, being applicable in only very limited situations/applications, requiring expertise and/or expense to maintain, being difficult to operate, requiring specific materials for its construction, having a difficult/complicated concept of operation, allowing particulates to pass forward in a fluid line, failing to protect orifices and other downstream fluid line devices/features, and requiring disassembly for filter cleaning.

What is needed is a back flushable filtering valve that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available back-flushable filter valves. Accordingly, the present invention has been developed to provide a filtered valve that is back-flushable.

According to one embodiment of the invention, there is a back-flushable filtered valve. The valve may include a valve body that may have a valve inlet and a valve outlet. The valve may include an inner core that may be disposed within the valve body between the valve inlet and the valve outlet. The inner core may be rotatably coupled to an interior of the valve body. The inner core may include an inner core flow path that may be defined by a hollow region between walls within the inner core. The inner core flow path may have a core inlet and a core outlet such that when the inner core is turned to a first mode fluid may thereby traverse the valve body by passing through the inner core.

The inner core may include a filter that may be disposed within the inner core flow path that may be substantially blocking the inner core flow path for particulates greater than the filter sizing. The valve may include a diversion outlet that may be spaced from the valve inlet and the valve outlet. The diversion outlet may be disposed through the valve body, and may be functionally coupled to the inner core such that when the inner core is turned to a second mode the side of the filter having particulates may face the diversion outlet and fluid may be able to back-flow through the filter and out the diversion flow outlet. The inner core flow path may be defined by asymmetric inner core walls: a first wall that is larger than a second wall, wherein the first wall in a first mode blocks the diversion outlet and in a second mode blocks the body outlet.

The back-flushable filtered valve may include a stop protrusion that may be functionally coupled to the inner core that may prevent the inner core from rotating beyond the second mode when rotating from the first mode to the second mode. The valve may include a flush supply inlet that may be through the valve body that may be spaced from the valve inlet, may be opposite the diversion outlet, may be separated from the valve inlet by a body of material, and may be functionally coupled to the inner core such that when the inner core is in a second mode, the flush supply inlet may supply fluid flow to the inner core flow path in reverse flow across the filter medium. The flush supply inlet may be directly coupled to the valve inlet within the valve body. The flush supply inlet may extend outside of the valve body separately from the valve inlet.

The valve may be an in-line valve that may be disposed within a fluid line and may include a pair of seals disposed about a perimeter of the valve body that may form a fluid tight seal between the valve body and an inner surface of the fluid line. The first mode and the second mode may be rotationally different from each other by a rotation of greater than 90 degrees and less than 180 degrees. The inner flow path may be offset from a central axis of the inner core. The valve may be disposed within a fluid dispensing system near a dispensing outlet and may include a handle that may be functionally coupled to the inner core such that a user of the fluid dispensing system may be able to change the valve between the first mode and the second mode, thereby flushing particulates out of the valve as desired.

According to one embodiment of the invention, there is a back-flushable filtered valve. The valve may include a valve body that may have a valve inlet and a valve outlet. The valve may include an inner core that may be disposed within the valve body between the valve inlet and the valve outlet and may be rotatably coupled to an interior of the valve body. The inner core may include an inner core flow path that may be defined by a hollow region between walls within the inner core. The inner core flow path may have a core inlet and a core outlet such that when the inner core is turned to a first mode fluid may thereby traverse the valve body by passing through the inner core. The inner core may include a filter that may be disposed within the inner core flow path that may be substantially blocking the inner core flow path for particulates greater than the filter sizing. The back-flushable filtered valve may include a diversion outlet that may be spaced from the valve inlet and the valve outlet, that may be disposed through the valve body, and may be functionally coupled to the inner core such that when the inner core is turned to a second mode the first side of the filter may face the diversion outlet and fluid may be able to back-flow through the filter from the fluid inlet and out the diversion flow outlet. The valve may include a handle protrusion that may be extending from the inner core through the valve body such that the inner core may be manipulated between the first mode and the second mode.

The valve's inner core flow path may be defined by asymmetric inner core walls: a first wall that is larger than a second wall, wherein the first wall in a first mode blocks the diversion outlet and in a second mode blocks the core outlet; or a flush supply inlet that may be disposed through the valve body that may be spaced from the valve inlet, may be opposite the diversion outlet, may be separated from the valve inlet by a body of material, and may be functionally coupled to the inner core such that when the inner core is in a second mode, the flush supply inlet may supply fluid flow to the inner core flow path.

The valve inlet and outlet each may include coupling structures that may be configured to couple to ends of a fluid line, thereby allowing the valve body to be serially placed within a fluid flow system. The back-flushable filtered valve may include a stop protrusion that may be functionally coupled to the inner core, either directly or through the handle protrusion, that may allow the inner core to rotate in one direction more than 90 degrees from the first mode but may prevent such rotation at an angle less than 180 degrees from the first mode. The valve may include a bias member that may be functionally coupled to the inner core that may bias the inner core in the first mode such that when the inner core is placed into a second mode and force is released from doing so, the inner core may spring back into the first mode.

According to one embodiment of the invention, there is a back-flushable fluid dispensing system. The system may include a fluid supply line. The system may include a back-flushable filtered valve that may be coupled to the fluid supply line. The system may include a valve body that may have a valve inlet and a valve outlet. The valve includes an inner core that may be disposed within the valve body between the valve inlet and the valve outlet and may be rotatably coupled to an interior of the valve body. The inner core may include an inner core flow path that may be defined by a hollow region between walls within the inner core. The inner core flow path may have a core inlet and a core outlet such that when the inner core is turned to a first mode fluid may thereby traverse the valve body by passing through the inner core. The inner core may include a filter that may be disposed within the inner core flow path substantially blocking the inner core flow path for particulates greater than the filter sizing.

The back-flushable filtered valve may include a diversion outlet that may be spaced from the valve inlet and the valve outlet, that may be disposed through the valve body, and may be functionally coupled to the inner core such that when the inner core is turned to a second mode the side of the filter having collected particulates during the first mode may face the diversion outlet and fluid may be able to back-flow through the filter and out the diversion flow outlet. The valve may include a handle protrusion that may be extending from the inner core through the valve body such that the inner core may be manipulated between the first mode and the second mode. The system may include a fluid dispensing head that may be functionally coupled to the back-flushable filtered valve such that fluid from the fluid supply line may be dispensed through the fluid dispensing head after being filtered by the back-flushable filtered valve.

The diversion outlet may be functionally coupled to a container for separately holding particulate matter from the valve. The inner core flow path may be defined by asymmetric inner core walls: a first wall that is larger than a second wall, wherein the first wall in a first mode may block the diversion outlet and in a second mode may block the body outlet. The system may include a stop protrusion that may be functionally coupled to the inner core, either directly or through the handle protrusion, that may allow the inner core to rotate in one direction more than 90 degrees from the first mode but may prevent such rotation at an angle less than 180 degrees from the first mode. The system may include a bias member that may be functionally coupled to the inner core that may bias the inner core in the first mode such that when an external force is applied to place the inner core into a second mode and subsequently the force is released from doing so, the inner core may spring back into the first mode.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIGS. 1-3 are top plan cross-sectional views of a back-flushable filtered valve having an off-axis inner flow path, wherein FIG. 1 is in a flow mode, FIG. 2 is in a transitional mode, and FIG. 3 is in a screen backflow mode, according to one embodiment of the invention;

FIGS. 4-6 are top plan cross-sectional views of an inline back flushable filtered valve, wherein FIG. 4 is in a flow mode, FIG. 5 is in a transitional mode, and FIG. 6 is in a filter backflow mode, according to one embodiment of the invention;

FIGS. 7-9 are top plan cross-sectional views of a back-flushable filtered valve having a centered inner flow path and a separated tandem inlet path, wherein FIG. 7 is in a flow mode, FIG. 8 is in a transitional mode, and FIG. 9 is in a filter backflow mode, according to one embodiment of the invention;

FIGS. 10-12 are top plan cross-sectional views of a back-flushable filtered valve having a centered inner flow path and a secondary inlet, wherein FIG. 10 is in a flow mode, FIG. 11 is in a transitional mode, and FIG. 12 is in a filter backflow mode, according to one embodiment of the invention;

FIG. 13 is a front elevational view of a back-flushable filtered valve, according to one embodiment of the invention;

FIG. 14 is a top plan cross-sectional view of a back-flushable filtered ball valve having a centered inner flow path and a secondary inlet path, according to one embodiment of the invention;

FIG. 15 is a top plan cross-sectional view of a back-flushable filtered valve having an offset inner flow path and a hollow core plug valve inset as illustrated in FIG. 16, according to one embodiment of the invention;

FIG. 16 is a perspective view of a hollow core plug valve inner core flow control element, according to one embodiment of the invention;

FIGS. 17-19 are top plan cross-sectional views of a back-flushable filtered valve, according to one embodiment of the invention; and

FIG. 20 is a side elevational view of a back-flushable fluid dispensing system, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

First reference is made in general to the various embodiments without specific reference to a particular figure but using the element numbers thereof so as to illuminate the great variety of various embodiments that may be implemented using the structures described herein. Accordingly, there may be a back-flushable filtered valve 150 as illustrated variously in drawings.

The valve 150 may include a valve body 101 having a valve inlet 112 and a valve outlet 105. The valve body will generally be of a solid material or fluid-tight assembly that encases an inner core 110 such that the inner core is actuable (e.g. rotatable). The inner core 110 is disposed within the valve body 101 between the valve inlet 112 and the valve outlet 105 and includes a flow path through which fluid may flow. Since the inner core is actuable, the flow path thereof may be altered by actuating the inner core (e.g. rotating it to block off a pathway). The inner core 110 may be rotatably coupled to an interior of the valve body 101 and such a coupling will generally be fluid tight to prevent fluid from flowing between the outer wall of the inner core and the inner wall of the valve body.

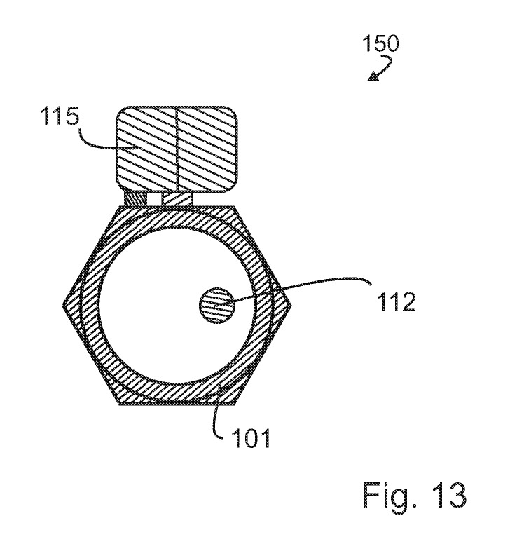

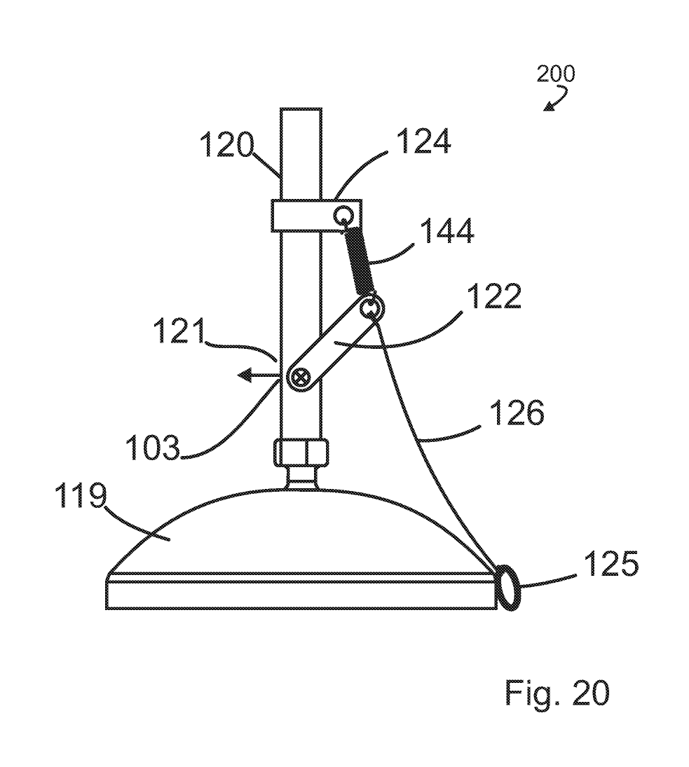

The inner core 110 includes an inner core flow path 108 defined by a hollow region between walls within the inner core 110. Such walls will generally be cylindrical, but may be of any shape that allows for an appropriate flow path. In the illustrated figures, the cross-sectional views are taken (excepting in the case of FIGS. 13 and 20) such that the illustrated wall cross-sections are in a plane of rotation of the inner core. The inner core flow path 108 includes a core inlet 130 and a core outlet 132 such that when the inner core 110 is turned to a first mode fluid may thereby traverse the valve body 101 by passing through the inner core 110, thus going in the inlet and out the outlet. When in a backflush mode, fluid will, generally, flow in the core outlet 132 and out the core inlet 130, and instead of flowing out of the valve body outlet, such will flow out of the diversion outlet 103. This reversed flow within the inner core is what allows particulate materials to exit the inner core body, as the inner core includes a back-flushable filter. A flexible seal 134 may be made integral to the core to enable the core to be made of inflexible material, providing a seal that seals off the diversion outlet 103 when the core is in the first mode, and when turned to the second mode, it seals off the primary outlet 105.

The inner core 110 includes a filter 106 disposed within the inner core flow path 108 that is substantially blocking the inner core flow path 108 for particulates greater than the filter sizing. The illustrated particulates 107 in the various figures are generally exaggerated for ease of viewing. The valve 150 includes a diversion outlet 103 spaced from the valve inlet 112 and the valve outlet 105. The diversion outlet 103 is disposed through the valve body 101, and is functionally coupled to the inner core 110 such that when the inner core 110 is turned to a second mode the first side of the filter 106 faces the diversion outlet 103 and fluid is able to back-flow through the filter 106 and out the diversion outlet 103. The diversion outlet could be drilled through the valve body or may be formed therewith, e.g. included within the casting or assembly. The inner core flow path 108 may be defined by asymmetric inner core walls, i.e. a first wall 110 that is larger than a second wall 136. Such an asymmetry allows for backflow through a diversion outlet without requiring asymmetry in the inlet and outlets of the valve body. However, wherein the valve body itself includes asymmetry(s) the inner core may be symmetrical. Alternatively, both may be symmetrical or asymmetrical, insomuch as such allows for proper flows in the various modes. It may be that a flexible seal body 134 in a first mode blocks the diversion outlet 103 and in a second mode blocks the body outlet 105.

The back-flushable filtered valve 150 may include a stop protrusion 104 functionally coupled to the inner core 110 (e.g. through an actuating handle 111) that prevents the inner core 110 from rotating beyond the second mode when rotating from the first mode to the second mode. The stop protrusion may be merely a post or nub stuck out sufficiently to block some portion of the associated handle from further rotation. Alternatively, the stop protrusion may be disposed entirely within the valve body and stop at its travel extremes e.g with a stepped cam feature integral to the core's design.

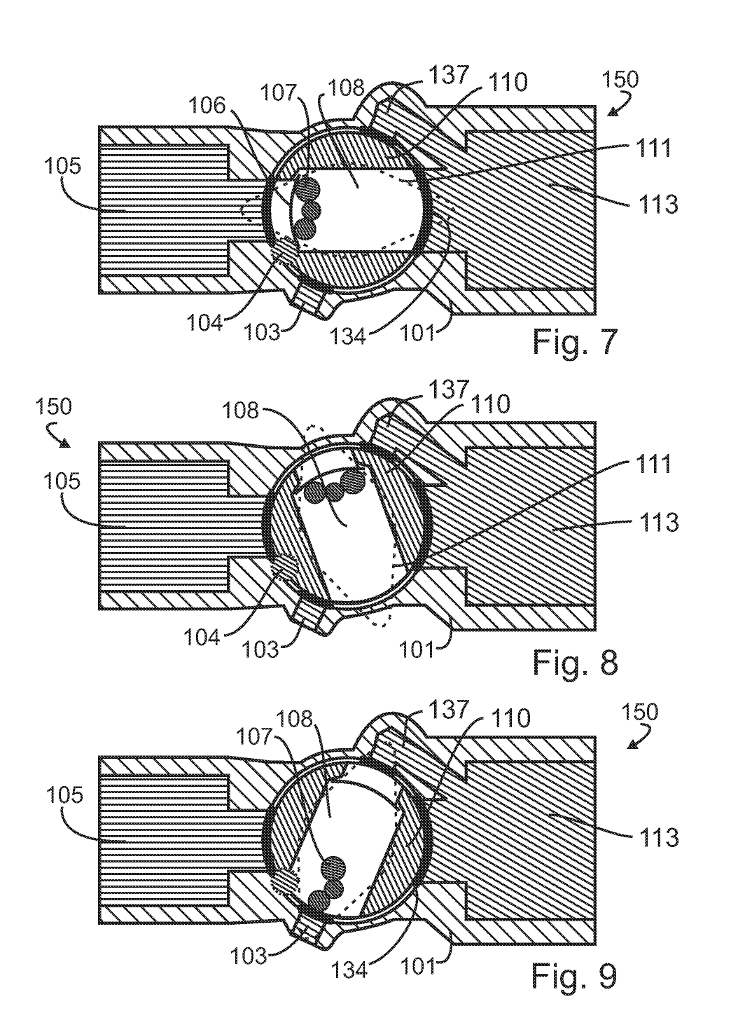

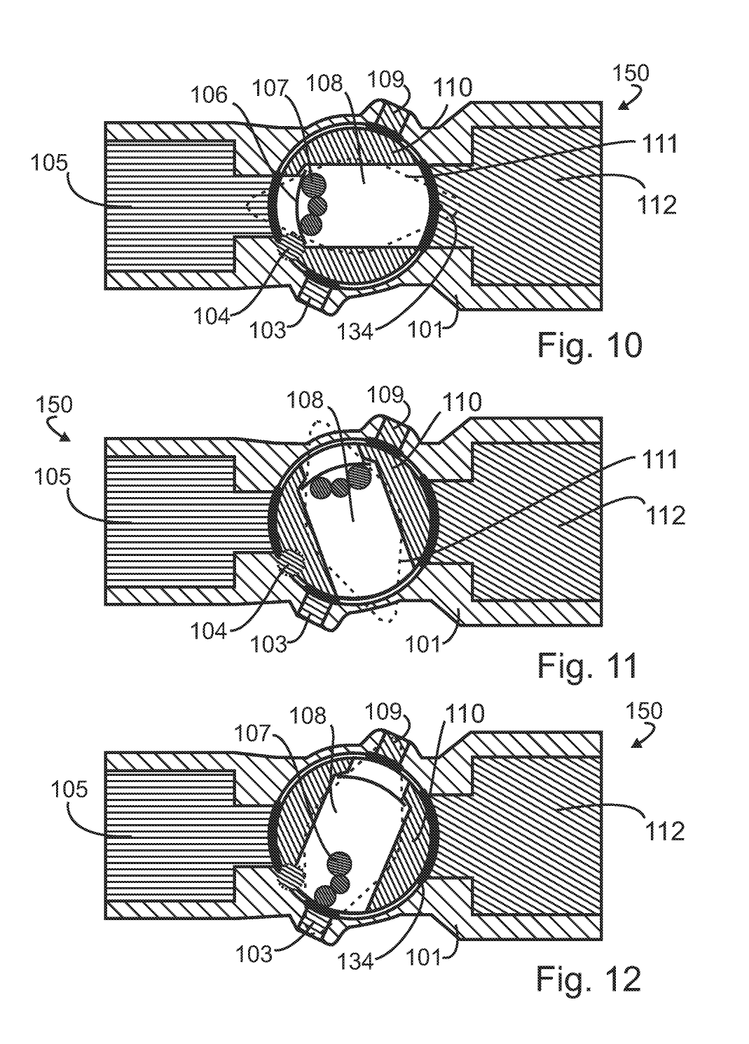

The valve 150 may include a separated tandem flush supply inlet path 137 (e.g. See FIGS. 7-9) through the valve body 101 spaced from the valve inlet 112, opposite the diversion outlet 103, separated from the valve inlet 112 by a body of material, and functionally coupled to the inner core 110 such that when the inner core 110 is in a second mode, the flush supply inlet path 137 supplies fluid flow to the inner core flow path 108. The additional separated tandem flush supply inlet path 137 is directly coupled to the valve inlet 112 within the valve body 101. The flush supply inlet path 137 communicates separately from the on-axis path in the valve inlet 112. Such is an example of an asymmetric valve body and a symmetric inner core as described previously (e.g. See FIGS. 10-12).

The valve may be an in-line valve 175 disposed within a fluid line and may include one or more seals 114 disposed about a perimeter of the valve body 101 that forms a fluid tight seal between the valve body 101 and an inner surface of the fluid line 138, thus preventing fluid from circumventing the valve.

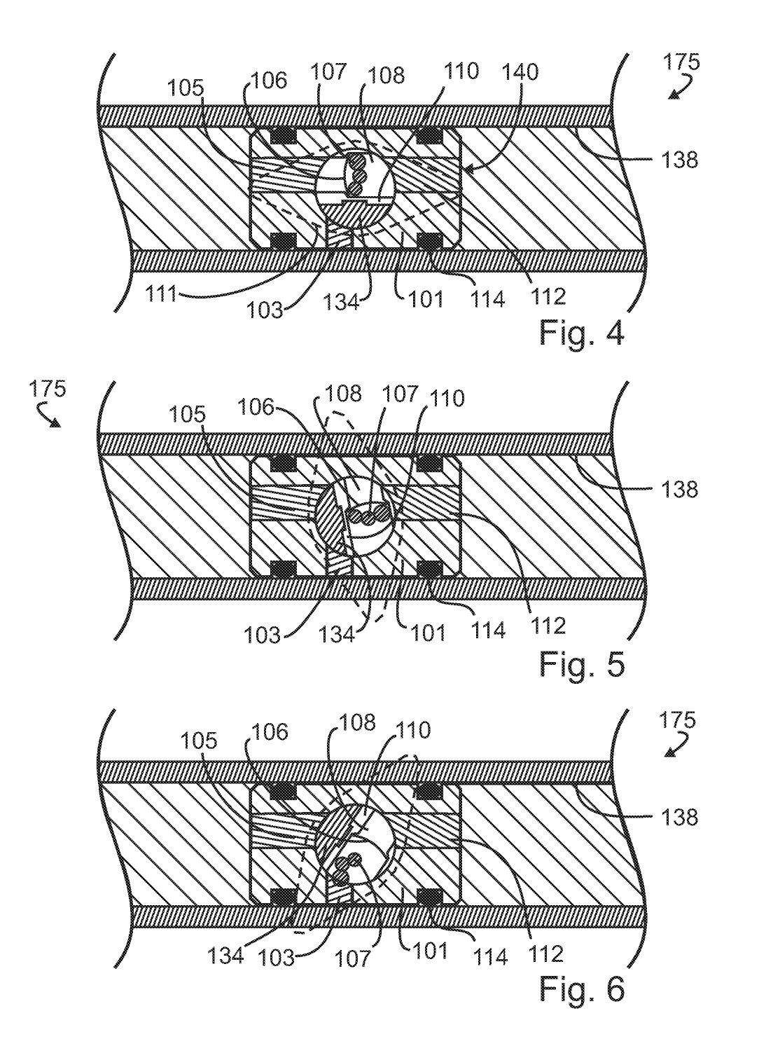

It may be that a valve includes a first mode wherein fluid flows through the valve normally, and a second mode wherein fluid back-flushes across the filter. The first mode and the second mode may be rotationally different from each other by a rotation of greater than 90 degrees and less than 180 degrees. Accordingly, such a rotation is less than a complete reversal of the inner core flow path, thereby preventing particulates from passing out the valve body outlet and thereby bypassing the valve and its filter. A stop protrusion or other structure configured to prevent 180 degree rotation of the valve may be included to enforce the limitation of the second mode being limited to less than a 180 degree rotation. An inner core flow path 108 may be offset from center axis of the fluid line; the body inlet 140 may likewise be offset from fluid line center axis (e.g. See FIGS. 4-6).

A valve may be disposed within a fluid dispensing system 200 near a dispensing outlet and may include a handle 122 functionally coupled to the inner core 110 such that a user of the fluid dispensing system 200 is able to change the valve between the first mode and the second mode, thereby flushing particulates out of the valve as desired.

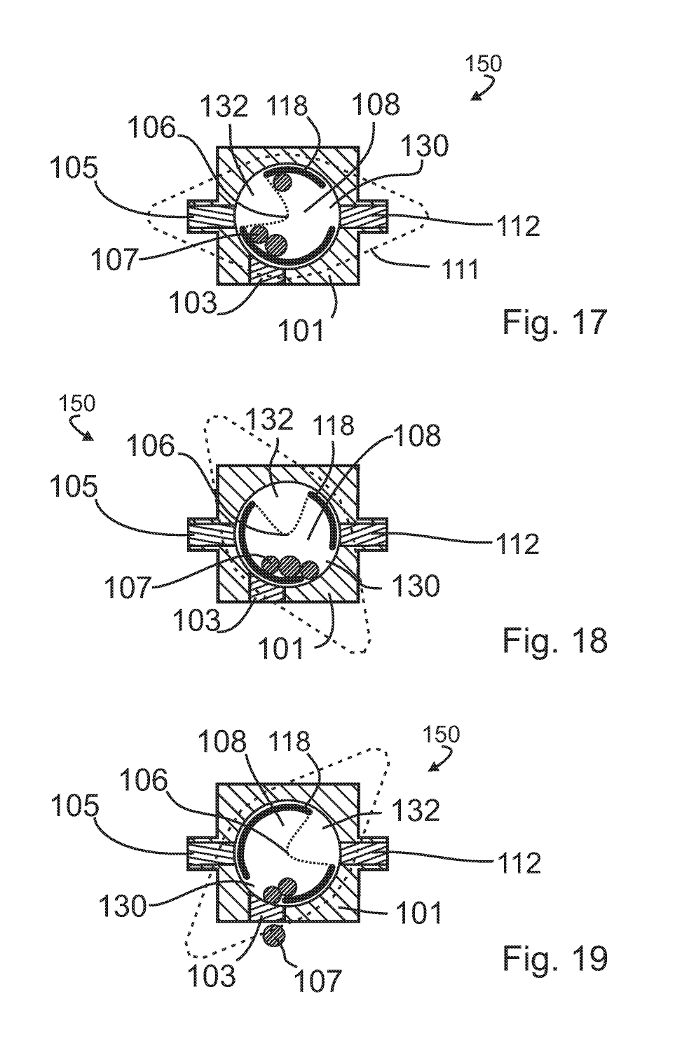

According to one embodiment of the invention (e.g. See FIGS. 17-19), there is a back-flushable filtered valve 150. The valve 150 includes a valve body 101 having a valve inlet 112 and a valve outlet 105. The valve 150 includes a hollow cylinder plug valve inner core 135 (e.g. See FIG. 16) disposed within the valve body 101 between the valve inlet 112 and the valve outlet 105 and is rotatably coupled to an interior of the valve body 101. The inner core 135 includes an inner core flow path 108 defined by a hollow region between walls 118 within the inner core. The inner core flow path 108 includes a core inlet 130 and a core outlet 132 such that when the inner core 110 is turned to a first mode fluid may thereby traverse the valve body 101 by passing through the inner core 135. The inner core 135 includes a filter 106 disposed within the inner core flow path 108 that substantially blocks the inner core flow path 108 for particulates greater than the filter sizing.

The back-flushable filtered valve 150 includes a diversion outlet 103 spaced from the valve inlet 112 and the valve outlet 105, disposed through the valve body 101, and functionally coupled to the inner core 110 such that when the inner core 110 is turned to a second mode the first side of the filter 106 faces the diversion outlet 103 and fluid is able to back-flow through the filter 106 and out the diversion outlet 103. The valve 150 includes a handle 115 communicating with the inner core 110 through the valve body 101 such that the inner core 110 is manipulated between the first mode and the second mode.

The valve 150 either includes the inner core flow path 108, which is defined by asymmetric inner core walls: (1) a first wall 110 that is larger than a second wall 136, wherein the first wall 110 in a first mode blocks the diversion outlet 103 and in a second mode blocks the core outlet 132 or (2) the valve 150 includes a flush supply inlet 109 disposed through the valve body 101 spaced from the valve inlet 112, opposite the diversion outlet 103, separated from the valve inlet 112 by a body of material 113, and is functionally coupled to the inner core 110 such that when the inner core 110 is in a second mode, the flush supply inlet 109 supplies fluid flow to the inner core flow path 108.

The valve inlet 112 and valve outlet 105 each include coupling structures 142 configured to couple to ends of a fluid line, thereby allowing the valve body 101 to be serially placed within a fluid flow system. The back-flushable filtered valve 150 includes a stop protrusion 104 functionally coupled to the inner core 110, either directly or through the handle protrusion 115, this allows the inner core 110 to rotate in one direction more than 90 degrees from the first mode but prevents such rotation beyond a predefined angle that is less than 180 degrees from the first mode. The valve 150 may include a bias member 144 functionally coupled to the inner core 110 that biases the inner core 110 in the first mode such that when the inner core is placed into a second mode and force is released from doing so, the inner core 110 springs back into the first mode.

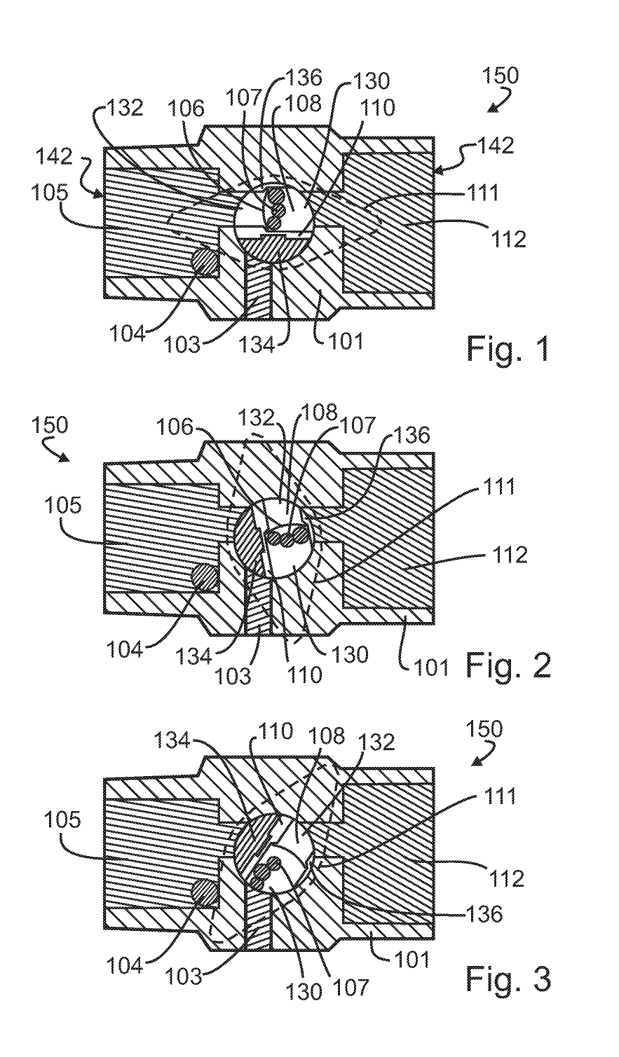

FIGS. 1-12, 14, 15 and 17-19 illustrate a plurality of top plan cross-sectional views of various back-flushable filtered valves, according to various embodiments of the invention. In each, there is shown a back-flushable filtered valve 150/175 including a valve body 101, a diversion outlet 103 or a diversion outlet, a valve outlet 105, a filter 106, particulate matter 107, an inner core flow path 108, an inner rotatable core 110, a valve position silhouette 111, a valve inlet 112, and a handle protrusion 115. Some of the illustrated valves also include one or more of: a flush supply inlet 109, a cartridge seal 114, a stop protrusion 104 or a rotation limiting stop pin, and an inlet with two pathways 113. FIG. 13 illustrates a side elevational view of a back-flushable filtered valve according to one embodiment of the invention to give perspective in regards to the other figures. FIG. 16 shows a perspective view of a hollow cylinder plug valve inner rotational flow control core.

Each of the illustrated back-flushable filtered valves provides for the collection and rerouting of suspended particulate matter in fluid flow streams within fluid lines (e.g. piping systems). In rerouting such material, each valve may be described as being a back-flushable filtering valve having improved characteristics over the art. Advantageously, the illustrated valves may be installed in a fluid channel (e.g. plumbing) within the fluid path and before any devices that may be sensitive to particulate matter (e.g. shower heads, faucets, chemical process equipment) and thereby trap such particulate matter. As desired, the valve may simply be rotated to a backflow mode and the particulate matter be routed to exit the filtering chamber within the valve by force of the fluid back-flowing therethrough. Such particulate matter may be collected and/or disposed of as desired. Advantageously, the illustrated valves transition to the backflow mode in a manner that prevents such particulate matter from having any opportunity to advance forward in the line towards the sensitive devices. Further, the back-flush operation that clears the filter of the collected sediment is simple and quick to perform and then normal flow may be easily and quickly restored without having to disassemble any portion of the fluid flow system.

In one non-limiting embodiment, there is a self-contained diverter valve that has a filter inside a rotatable inner core thereof. The valve includes an inlet and an outlet, plus an additional diversion outlet through which fluid may be ejected. The valve includes a flow position wherein fluid flows in the inlet and out the outlet. The valve includes an off position wherein no fluid flows. The valve includes a third valve position, beyond the “OFF” position, wherein fluid back-flushes through the filter (i.e. a screen backflow mode) and is ejected out of the additional port along with any particulate matter trapped by the filter. The inlet and outlet of the valve are functionally coupled to the fluid line/piping in series therewith. The additional port may merely eject outside the system (e.g. just into the air/space around the fluid line) or may include its own fluid line to a collection and/or particulate processing system.

According to one embodiment of the invention, there is a valve including an outer valve body, an inner valve body disposed within the outer valve body, a handle/turning structure functionally coupled to the inner valve body, a filter disposed within the inner channel and functionally coupled to the flow path thereof, a discharge channel functionally coupled to the inner valve body such that in a discharge mode the discharge channel may discharge fluid therethrough, an inlet in fluid communication with the inner valve body, an outlet in fluid communication with the inner valve body, and an inner channel formed within the inner valve body.

A notable example of use of one or more of the illustrated embodiments is wherein such a valve is installed between a shower head and the line supplying water to that shower head, thereby protecting the bathroom shower head's orifices. The back-flushable filtering valve may be a separate valve that is placed in line between the water feed pipe and the shower head, or it may be incorporated within the pipe itself as a containing body, or it may be incorporated within the design of the shower head itself as an alternate containing body. Each embodiment would include a diversion outlet for disposal of particulates, and a handle or other control structure/device to operate the valve between its positions (generally between ON, OFF, and BACKFLUSH). This provides the user an effective way to protect a shower head, as well as a convenient way to restore normal flow when significant particulates have been collected, by instantly cleaning the filter without expense, tools or expertise.

There are many other situations in which a small, simple, and/or economical valve with integral limited capacity particulate filtering is incorporated within the core and back-flushing capability is included in the valve's operation as a third operational position. For example, irrigation systems on farms have sand, sticks, bugs, dirt and other material that gets into the lines when open to the elements. Some such particulates may be flushed during set-up. Others will find their way to the spray nozzles while in use. A valve sized for this application allows the farmer to keep his nozzles clean, and quickly service the valve when necessary to avoid crop circles. There may also be suitable uses of similar valves in manufacturing, science, medicine, and the like and combinations thereof wherein it is desired to selectively filter particulates from a fluid stream and then selectively back-flush such particulates into an additional stream as desired with only simple operation of a single valve without risk of contaminating a main down-line with such particulates and without requiring any disassembly or removal of any filters.

While the described applications/examples presume that the particulates cause problems and should be removed because of those problems, such may not always be the case. Indeed, there may be situations where the particulates are desired (e.g. heavy metal particles like gold, micro-dosed particulate medicine, chemical precipitates) and such a valve could be used in a system designed to control the density/concentration of such and/or collect particulates of selected granular sizes for distribution to a different fluid line and/or for some desired use.

The various figures and embodiments illustrated thereby are numbered such that similar structures are given the same element numbers. For clarity, while the valve body of FIGS. 1-3 are intended to be the same valve body and numbered with the numeral “101”, the valve body of FIGS. 4-6 are also marked with the numeral “101” to reflect that such is a valve body, but it is not the same valve body as that illustrated in FIGS. 1-3. The rest of the figures follow a similar pattern, with each set of figures (i.e. FIGS. 1-3, 4-6, 7-9, and 10-12) having the same structure within the figure sets but all figures using the same numbering scheme to illustrate similar, but not identical, structures. The following is a general description of the illustrated structures and such description applies to all Figures wherein that structure is present unless otherwise indicated.

A valve body 101 is shaped to support and house the other parts of the valve disposed therein. The valve body also generally includes structure needed to couple to a fluid line and forms the inlets and outlets. Such a valve body may be embodied in various ways, including but not limited to one or more of: being a fluid channel, the shape and form of a standard ball valve or other similar valve having a rotatable inner flow path (e.g. full port, reduced port, V port, cavity filled, trunnion, and/or multi-port ball valves), being shaped to insert into a fluid line (e.g. pipe, showerhead), the body of the showerhead itself or other fluid channel device, one or more flow structures that channel fluid to an inner valve body in different ways. Such a valve body may have secondary flow paths and/or secondary inlets/ports. Such a valve body may be constructed in various manners including but not limited to being cast, machined, and/or plastic injection molded. The valve body 101 may functionally couple to one or more fluid lines by operation of connection system(s) including but not limited to mating threads, snap-fit, friction fitting, glue, and the like and combinations thereof.

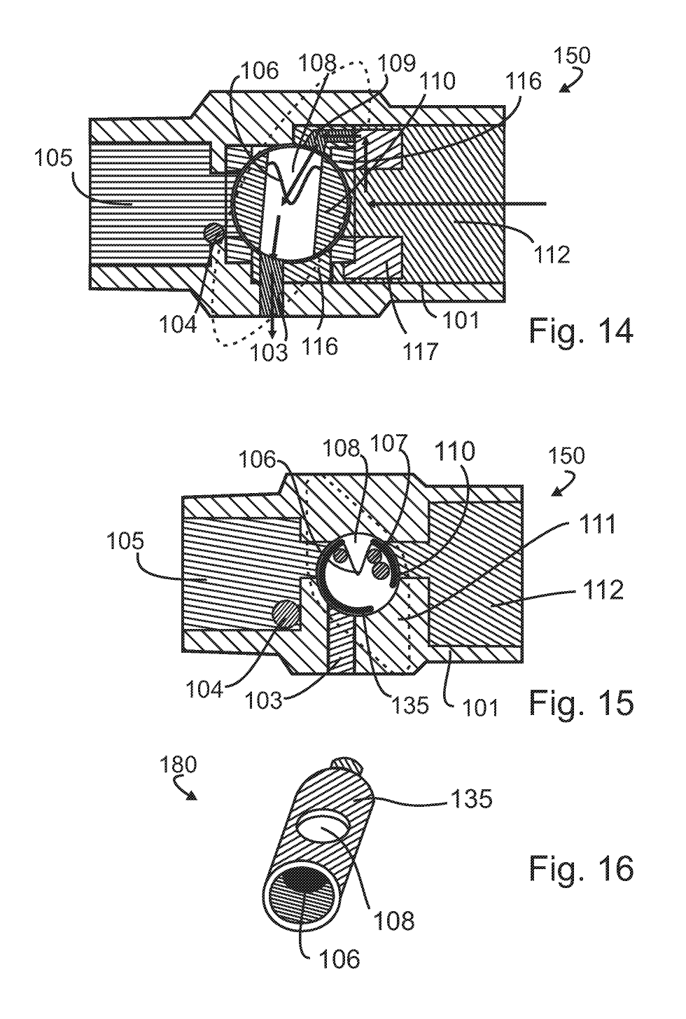

An inner valve body/core 110 (e.g. the ball of the ball valve, See FIG. 14) is shown. Such an inner valve body is disposed within the valve body and is rotationally coupled thereinside. The inner valve body may form a filter framing structure that houses a filter 106 and prevents the same from moving laterally through the line and/or from being bypassed by fluid. The inner valve body and filter may be integral to each other such that the filter is simply a structural feature of the inner flow path 108 through the inner valve body.

An inner core 110 will generally have a single fluid path therethrough, but it is possible for it to have multiple channels. There may be embodiments wherein such multiple channels are configured to allow for constant flow to occur even when in a backwashing mode for one of the channels. As a non-limiting example, a single ball valve may include a plurality of parallel channels that are offset from each other such that when one channel is in an ON mode (normal flow) another is in a BACKFLUSH mode. Accordingly, such a valve could always be ON even when performing a backwash across a filter. The inner rotatable core 110 is configured to rotate to either open or close an opening between the valve outlet 105 and the valve inlet 112, thereby allowing fluids to pass therethrough. The inner rotatable core 110 is also configured to block the opening between the valve inlet 112 and the valve outlet 105 and open a pathway to the diversion outlet 103, thereby allowing particulates to be flushed from a filter 106.

An inner seal is typically disposed within the valve body 101, which is configured to restrict flow between a valve outlet 105 and a valve inlet 112 of the valve. Generally, such a seal is part of a core body or housing for the core, e.g. which may enclose a “ball” portion of a ball valve (See FIG. 14.), but may include other structures as well that cooperate to prevent flow when the valve is in an OFF and/or BACKFLUSH mode. Generally, the seal stays stationary within the body and the core (e.g. ball) rotates against the seal to make sure all flow is restricted to the path chosen by the position of the core and its internal pathway(s), or in the case of a minimum flow requirement system from the inlet to the outlet, an additional flow path feature minimally bypasses the seal.

A diversion outlet 103 or secondary outlet 103 is disposed within the valve body 101 and is designed to provide a port for particulates to be ejected from the valve therefrom. Such a port is generally disposed out of line with the outlet and inlet and is positioned and oriented with respect to the inner valve body and its inner flow path such that when the inner valve body is rotated by operation of the handle the diversion outlet is accessible to the inlet through the filter in a BACKFLUSH mode.

A stop protrusion 104 is configured to limit the rotation of an inner rotatable core 110 of the valve. The illustrated stop protrusion is positioned and oriented to limit a range of motion of the handle such that the inner flow path cannot be reoriented to a position wherein fluid backflows through the filter from the inlet to the outlet. The range of motion limiting feature may be implemented using a stop protrusion disposed in/on the valve body or be composed of features of other components that similarly limit a range of motion of the handle and/or inner valve core and may be something other than an elongated protrusion. There may be one or more flanges, checks, lips, channels, blocks or the like that may limit the rotational freedom of the handle and/or inner valve body such that undesired modes may be eliminated/prevented. The rotation limiting feature may be implemented and become inherent in the design by virtue of a bale type handle which self-limits the range of valve motion upon contacting the valve body at either extreme of its motion.

The filter 106 or filter element is shaped and positioned to catch particulate matter 107 in the flow path between the valve inlet 112 and the valve outlet 105. Generally such a filter will be embodied as a screen or other membrane (e.g. woven fibers, plastic grid) having an effective aperture size smaller than a size of particulate matter intended to be caught thereby. The filter may be flat or may have a contoured surface. Generally, such a filter will be fixed within the inner core such that fluid flow, forward or backwards, does not alter a position of the filter. The filter will generally extend across an entire cross-section of the fluid path such that fluid must flow therethrough in order to proceed down the line. It is advantageous if the filter is of a type that does not trap particulate materials within a body of the filter, but instead merely blocks the same from traversing the filter. Accordingly, when the filter is back-flushed, the particulate matter may readily and quickly disengage from the filter and be swept out the diversion outlet.

The filter and/or inner core 110 may be removable and/or replaceable components (e.g. in applications that benefit from lifecycle maintenance of the valve). Filters may be of a variety of materials but must be sufficiently rugged to handle the operating conditions. There may be various filter rating, types, sizes, multiple layers of filters, and the like and combinations thereof. In the case of the illustrated valves, such a filter should be sufficiently rugged to handle great amounts of use so as to continue to operate without failing/tearing for long periods of time. The filter element may be constructed of a suitably resilient, strong, and chemically compatible material that provides the necessary filtering mechanics, yet is flexible enough to allow for mechanically reversing its geometry during back-flush cycle in a manner that would provide the necessary mechanical forces to assist in mechanically breaking off chemically deposited and brittle scale films that may have built up on the surface of the filtering medium during normal operation.

An inner core flow path 108 is configured to provide fluid communication between the valve inlet 112 and the valve outlet 105 when the inner rotatable core 110 is positioned for normal function. The inner flow path may be simple, essentially a cylindrical or elliptical hole through a center of the inner valve body, or it may be diverse from such, including but not limited to being stepped, off-center, multiple holes, cone-shaped, plug/cylinder shaped, and the like and combinations thereof. Further, the orifice thereof may be shaped and/or contoured to provide particular operational effects, such as but not limited to a V-shaped orifice that provides for more linear flow characteristics during a transition between ON and OFF. There may be a structure incorporated (not shown) into the inner core flow path sealing the area between the core 110 and the seals and/or the inner rotatable core that allows for a minimum flow of fluid from the inlet source to flow between the inlet and the outlet during the transitional phase between on and off, and/or being cut off when the flow makes the transition to the flush position, wherein particulate matter is not allowed to contaminate the outlet flow path, allowing for minimum inlet service flow to be maintained at all degrees of rotational movement.

The illustrated valves each include some structure that allows for fluid flow through the inner valve body when in a BACKFLUSH mode. The various illustrated embodiments provide diverse structures for accomplishing the same. In particular, FIGS. 1-6 include an off-axis inner flow path, FIGS. 7-9 include a separated tandem inlet flow path, and FIGS. 10-12 include a secondary inlet not in communication with the primary inlet. Such structure allows for an alternative fluid flush supply to clean out the filter 106 through the diversion outlet that differs from the main fluid material when in a BACKFLUSH mode, while simultaneously blocking flow to the primary outlet while in that same mode.

There is a valve handle 111 which is in mechanical communication with the illustrated inner core, disposed within the valve body during operation. It is illustrated as a valve position silhouette. The valve handle also interacts with the illustrated stop protrusion 104. As an example, in FIG. 1 the handle is pressed against the stop protrusion such that counter-clockwise motion of the handle is restricted by the stop protrusion, while in FIG. 3, the handle is pressed against the stop protrusion such that clockwise motion of the handle is restricted by the stop protrusion. Accordingly, the shape, size, and relative positions of the handle and stop protrusion can cooperate to effectively limit the modes of the valve to only those desired. A handle may be coupled to an inner valve body, may be integral thereto, may be unitary therewith, may be a handle shaped and configured to be operated manually, and/or may be shaped and configured to be operated by a control system (e.g. automated, pneumatic, electronic control). There may be a plurality of handles, e.g. wherein there are two handles on opposite sides of the valve. There may be a bale-type handle. There may be a spring-loaded or otherwise energized self-return structure incorporated into and/or functionally coupled to return the valve and bias it in a normal flow position when unattended.

Looking specifically to the figure sets, FIGS. 1-3 are top plan cross-sectional views of a valve having an off-center inner flow path, wherein FIG. 1 is in a flow mode, FIG. 2 is in a transitional mode with the handle having been turned almost 90 degrees clockwise with respect to the flow mode handle position, and FIG. 3 is in a screen backflow mode with the handle having been turned over 90 degrees clockwise with respect to the flow mode handle position, according to one embodiment of the invention. For examples of embodiments with an on-axis inner flow path, See FIGS. 7-9 and 10-12.

This figure set is an example wherein a filter element is incorporated into a plug valve's inner core's flow path which is horizontally located off the normal central axis, allowing for a third port and a third valve position whereby the third port routes the fluid flow to the exterior and positioned conveniently so that when the core is rotated to this third position, the flow from the input will reverse flush the collected particulates through the diversion outlet, thereby bypassing the outlet path way and continuously protect a downstream device from particulate contamination. The seal is significantly larger than the corresponding structure on the opposite side of the inner valve body. Such facilitates appropriate sealing of the diversion outlet and/or the outlet path way for various modes of operation. The setting of the illustrated inner valve body is also off-axis with respect to its housing within the valve body.

According to one embodiment of the invention, there is a multifunctional flow control or diversion valve for fluids which incorporates a screen filter in its rotatable core and a feature to reverse-flush collected particulate matter from the filter through an ejection port. The filter, being located within the rotatable core section of the flow path, creates a repositionable internal filtering chamber for particles. The body design of the valve has input and output pathways located strategically to provide three functional positions: at one positionally limited extreme, the flow is normal, or ‘ON’; an intermediate position, where the normal flow is restricted, perhaps 100%; and at the other extreme limited position, a reverse-flow pathway is opened up through the core to an ejection port, whereby the particles trapped in the filtering chamber are forcibly and immediately expelled by the incoming fluid used as a cleaning solution. When the valve is returned to the other extreme limited ‘ON’ position, the maximum flow of fluid allowed by the design is then restored for normal function.

FIGS. 4-6 are top plan cross-sectional views of an inline valve, wherein FIG. 4 is in a flow mode, FIG. 5 is in a transitional mode with the handle having been turned almost 90 degrees clockwise with respect to the flow mode handle position, and FIG. 6 is in a screen backflow mode with the handle having been turned over 90 degrees clockwise with respect to the flow mode handle position, according to one embodiment of the invention.

The illustrated valve includes a plurality of seals 114 that provide a seal between the valve body 101 and a fluid conduit. Such seals may be cartridge seals such that the valve is installed/inserted into the line in a cartridge-like manner. Accordingly, the illustrated valve may be installed in-line with a fluid conduit. In operation, during installation a hole may be drilled to allow for fluid to exit the line from the diversion outlet 103 and another hole may be drilled to provide handle access. The illustrated cartridge seals prevent fluid from leaking through such apertures where present and prevent fluid from bypassing the valve. Such seals may include one or more O-rings of elastic material, such as but not limited to rubbers, silicone, plastics, resins, oils, and the like and combinations thereof.

FIGS. 7-9 are top plan cross-sectional views of a valve having a centered inner flow path and a secondary inlet path, wherein FIG. 7 is in a flow mode, FIG. 8 is in a transitional mode with the handle having been turned almost 90 degrees clockwise with respect to the flow mode handle position, and FIG. 9 is in a screen backflow mode with the handle having been turned over 90 degrees clockwise with respect to the flow mode handle position, according to one embodiment of the invention.

This illustrated figure-set shows wherein the inner core geometry is designed as a normal plug valve, yet the interior of the valve body has been modified by both having the previously described ejection port, but additionally has a secondary internal pathway coming from the incoming fluid supply line routed to a position 180 degrees from the diversion outlet, such that when the core is rotated to the flush position, this flow path enables a reverse flush operation of the filter element. The illustrated secondary pathway is formed by an enlarged exterior region opposite the diversion outlet 103 with a channel extending therethrough such that fluid may still enter the inner core when the inner core is aligned with the diversion outlet.

FIGS. 10-12 are top plan cross-sectional views of a valve having a centered inner flow path and a secondary inlet, wherein FIG. 10 is in a flow mode, FIG. 11 is in a transitional mode with the handle having been turned almost 90 degrees clockwise with respect to the flow mode handle position, and FIG. 12 is in a screen backflow mode with the handle having been turned over 90 degrees clockwise with respect to the flow mode handle position, according to one embodiment of the invention;

This illustrated figure-set shows a separate fluid supply port 109 used to backflush the filter element. This additional inlet is not part of the primary internal fluid pathway connected to the incoming fluid, but is an additional port that is exposed to the exterior, allowing for an alternate flushing fluid to be used for that purpose, or perhaps higher pressure fluid or air supply for more efficient clearing of particulates. Accordingly, fluid having characteristics different from the fluid in the primary fluid conduit may be utilized in the backflush process. Such may allow for solvents and/or cleaning agents to be used to clean and/or sanitize the filter as needed. Such may also permit the use of a plurality of diverse fluids in the backflush process without contaminating the primary fluid.

In another aspect, this disclosure provides to the art the convenience of utilizing a small, simple, and/or economical back-flushable filtering device, with the additional convenience of utilizing various alternate fluids to improve the flush operation used to clean the filtering element which may be desirable in some applications by incorporating an additional input port for use during flush operations.

FIG. 13 is a front elevational view of a valve, according to one embodiment of the invention wherein the flow path is shown off center of the piped central flow axis. There is shown a valve including a handle protrusion 115, a valve inlet 112, and a valve body 101.

According to one embodiment of the invention, there is a valve to provide fluid to pass therethrough, including a valve body 101 configured to support the components and parts of the valve and also support the pathway for fluid to pass through the valve during operation. The valve includes a valve inlet 112 disposed within the valve body 101 and configured to allow fluid to enter the valve therefrom. The valve includes a handle protrusion 115 disposed on an exterior surface of the valve body 101, to facilitate the opening and closing of an inner rotatable core disposed within the valve body 101.

FIG. 14 illustrates a top plan cross-sectional view of a ball valve in a backflush mode with arrows illustrating flow of fluid through the valve. The fluid flows in through the inlet and backwashes through the illustrated filter and then out a secondary outlet through the valve body. There are shown an elastomeric seal 116 and a seal clamp 117 that operate together to properly seal the valve.

FIGS. 15-16 illustrate a top plan cross-sectional view of a hollow core plug valve 180 having an off-center inner core flow path formed by a hollow body with curved exterior walls. The illustrated valve is in an OFF mode wherein fluid flow is restricted by the valve. The relative angular positioning of the openings in the inner core as well as the positioning of the inlet, outlet, and secondary outlet are configured to align together to form three modes: ON, OFF, and BACKFLUSH. FIG. 16 is a perspective view of the hollow core plug valve inner core flow control element 135 including a filter 106 disposed adjacent an inner core flow path 108.

FIG. 17-19 illustrate top plan cross-sectional view of a valve body 101 having a relatively larger collection cavity (relative to the size of valve inlet 112 and valve outlet 105 primary flow path connections with a larger hollow inner core body 118 with a circular cross-section in an ON mode (FIG. 17), an OFF mode (FIG. 18), and a BACKFLUSH mode (FIG. 19).

The relative angular positioning of the openings in the inner core as well as the positioning of the inlet, outlet, and secondary outlet are configured to align together to form three modes: ON, OFF, and BACKFLUSH. The effective arc lengths of the walls of the inner core form an asymmetric flow path that allows for diversion through the diversion outlet while blocking flow through the outlet during a backflush mode.

FIG. 20 is a side elevational view of a back-flushable fluid dispensing system, according to one embodiment of the invention. There is shown a back-flushable fluid dispensing system 200 including a fluid supply line 120, a back-flushable filtered valve disposed within the fluid supply line near illustrated region 121, a mount 124 for supporting a bias member 144 coupled to a lever 122 acting as a handle to actuate the valve, an attachment member 126, an actuation member 125, and a fluid dispensing head 119. Advantageously, the illustrated system allows for a user to easily cause back-flushing through the valve to clear out the same by pulling the illustrated actuation member (ring) near the shower head and the system immediately springs back into a flow-mode when the ring is released by the user. Accordingly, the user may easily, effectively, conveniently, and quickly clear the filter without tools and without a substantial interruption to the normal use of the system/shower.

The illustrated back-flushable fluid dispensing system 200 includes a fluid supply line 120. The system 200 includes a back-flushable filtered valve (e.g. 175 of FIGS. 4-6) coupled to the fluid supply line 120. Such a system could include a back-flushable filtered valve installed inline between the supply pipe and the shower head instead of coupling the supply pipe directly to the shower head. In such a situation, the various other embodiments of valves illustrated herein may be used.

The valve allows for easy and quick back-flushing of a filter element disposed therein and the illustrated system shows a non-limiting example of how that may be present within the system to allow convenient use by a user thereof. The valve may include a valve body that may have a valve inlet and a valve outlet. The valve includes an inner core disposed within the valve body between the valve inlet and the valve outlet and is rotatably coupled to an interior of the valve body. The inner core includes an inner core flow path defined by a hollow region between walls within the inner core. The inner core flow path has a core inlet and a core outlet such that when the inner core is turned to a first mode fluid may thereby traverse the valve body by passing through the inner core. The inner core includes a filter disposed within the inner core flow path substantially blocking the inner core flow path for particulates greater than the filter sizing.

The back-flushable filtered valve includes a diversion outlet 103 spaced from the valve inlet and the valve outlet, that is disposed through the valve body, and is functionally coupled to the inner core such that when the inner core is turned to a second mode the first side of the filter faces the diversion outlet and fluid is able to back-flow through the filter and out the diversion flow outlet. The valve includes a handle protrusion extending from the inner core through the valve body such that the inner core is manipulated between the first mode and the second mode. The system 200 includes a fluid dispensing head 119 functionally coupled to the back-flushable filtered valve such that fluid from the fluid supply line is dispensed through the fluid dispensing head after being filtered by the back-flushable filtered valve.

The diversion outlet is functionally coupled to a container for separately holding particulate matter from the valve. The inner core flow path is defined by asymmetric inner core walls: a first wall that is larger than a second wall, wherein the first wall in a first mode blocks the diversion outlet and in a second mode blocks the core outlet. The system includes a stop protrusion functionally coupled to the inner core, either directly or through the handle protrusion, that allows the inner core to rotate in one direction more than 90 degrees from the first mode but prevents such rotation beyond a predefined angle that is less than 180 degrees from the first mode. The system 200 includes a bias member functionally coupled to the inner core that biases the inner core in the first mode such that when the inner core is placed into a second mode and force is released from doing so, the inner core springs back into the first mode.

The illustrated back-flushable fluid dispensing system 200 includes a fluid supply line 120 such as a water supply line to a shower head. The fluid supply line 120 is functionally coupled to a back-flushable filtered valve. The back-flushable filtered valve is configured to back-flush particulates from a filter disposed within the valve. The system 200 includes a mount 124 and a lever 122 functionally coupled together by a bias member 144. The lever 122 is functionally coupled to an actuation member 126 by an attachment member 126, such as a wire. The system 200 includes a fluid dispensing head 119 functionally coupled to the back-flushable filtered valve.

The illustrated valves are configured to be more convenient, smaller, simpler, less complex, cheaper, more durable, more reliable, easier to maintain, easy to install, applicable to many applications, great variety of applications, usable in a much more broad set of applications, does not require expertise or expense to maintain, simple to operate, no specific materials are required for its construction, concept of operation is easy to understand, keeps materials from passing forward in the line, and does not require disassembling to clean the filter.

While a “shower” type system is illustrated, it is understood that similar systems may be utilized in a great variety of fluid systems where clearing a filter may be desired, and such is not limited to showers or even residential fluid systems (e.g. sinks, faucets, toilets, inside shower control enclosures, control valves, walls and ceilings in supply lines in proximity to orifices needing protection) but may be implemented within any fluid system where a filter may be of use, including but not limited to commercial systems, laboratory systems, experimental setups, spacecraft/airplane fluid systems, fluid cooling systems, fluid systems in power plants, and the like and combinations thereof.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate phantom handles and/or levers, the valve may be controlled by one or more of various tools, equipment, controls, solenoids, machines, computers, actuators, hydraulic pistons, levers, knobs, and the like and combinations thereof.

Additionally, although the figures generally illustrate solid housings, it is understood that there are a multiplicity of methods of constructing valve housings, including but not limited to cast housings, composite housings, molded housings, 3D printed housings, assembled housings, and the like and combinations thereof.

It is also envisioned that there may be more than one inlet, outlet, and diversion outlet within a particular valve and that such may allow the valve to perform additional functions.

It is expected that there could be numerous variations of the design of this invention. An example is that the valve may include diverse mating connections on each side, such that it may couple to different types of pipe or modules within a fluid system.

Finally, it is envisioned that the components of the device may be constructed of a variety of materials, including but not limited to metals, ceramics, woods, woven fibers, composites, stone, glass, cements, rubbers, plastics, elastomers, resins, and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A back-flushable filtered valve, comprising:
a. a valve body having a valve inlet and a valve outlet,
b. an inner core disposed within the valve body between the valve inlet and the valve outlet and rotatably coupled to an interior of the valve body, including:
i. an inner core flow path defined by a hollow region between walls within the inner core, the inner core flow path having a core inlet and a core outlet such that when the inner core is turned to a first mode fluid may thereby traverse the valve body by passing through the inner core; and
ii. a filter disposed within the inner core flow path substantially blocking the inner core flow path for particulates greater than the filter sizing, the filter having a first side and a second side wherein on the first mode the first side faces fluid flow thereby trapping particulates therein; and
c. a diversion outlet spaced from the valve inlet and the valve outlet, disposed through the valve body, and functionally coupled to the inner core such that when the inner core is turned to a second mode the first side of the filter faces the diversion outlet and fluid is able to back-flow through the filter and out the diversion flow outlet.

2. The valve of claim 1, wherein the inner core flow path is defined by asymmetric inner core walls: a first wall that is larger than a second wall, wherein the first wall in a first mode blocks the diversion outlet and in a second mode blocks the core outlet.

3. The valve of claim 2, further comprising a stop protrusion functionally coupled to the inner core that prevents the inner core from rotating beyond the second mode when rotating from the first mode to the second mode.

4. The valve of claim 1, further comprising a flush supply inlet through the valve body that is spaced from the valve inlet, opposite the diversion outlet, separated from the valve inlet by a body of material, and functionally coupled to the inner core such that when the inner core is in a second mode, the flush supply inlet supplies fluid flow to the inner core flow path.

5. The valve of claim 4, wherein the flush supply inlet is directly coupled to the valve inlet within the valve body.

6. The valve of claim 4, wherein the flush supply inlet extends outside of the valve body separately from the valve inlet.

7. The valve of claim 1, wherein the valve is a cartridge-style valve disposed within a fluid line and including a pair of seals disposed about a perimeter of the valve body that form a fluid tight seal between the valve body and an inner surface of the fluid line.

8. The valve of claim 1, wherein the first mode and the second mode are rotationally different from each other by a rotation of greater than 90 degrees and less than 180 degrees.

9. The valve of claim 1, wherein the inner flow path is offset from an axis of the inner core.

10. The valve of claim 1, wherein the valve is disposed within a fluid dispensing system near a dispensing outlet and includes a handle functionally coupled to the inner core such that a user of the fluid dispensing system is able to change the valve between the first mode and the second mode, thereby flushing particulates out of the valve as desired.

11. A back-flushable filtered valve, comprising:
a. a valve body having a valve inlet and a valve outlet,
b. an inner core disposed within the valve body between the valve inlet and the valve outlet and rotatably coupled to an interior of the valve body, including:
i. an inner core flow path defined by a hollow region between walls within the inner core, the inner core flow path having a core inlet and a core outlet such that when the inner core is turned to a first mode fluid may thereby traverse the valve body by passing through the inner core; and
ii. a filter disposed within the inner core flow path substantially blocking the inner core flow path for particulates greater than the filter sizing, the filter having a first side and a second side wherein on the first mode the first side faces fluid flow thereby trapping particulates therein;
c. a diversion outlet spaced from the valve inlet and the valve outlet, disposed through the valve body, and functionally coupled to the inner core such that when the inner core is turned to a second mode the first side of the filter faces the diversion outlet and fluid is able to back-flow through the filter and out the diversion flow outlet; and
d. a handle protrusion extending from the inner core through the valve body such that the inner core may be manipulated between the first mode and the second mode.

12. The valve of claim 11, wherein either:
a. inner core flow path is defined by asymmetric inner core walls: a first wall that is larger than a second wall, wherein the first wall in a first mode blocks the diversion outlet and in a second mode blocks the core outlet; or
b. a flush supply inlet is disposed through the valve body that is spaced from the valve inlet, opposite the diversion outlet, separated from the valve inlet by a body of material, and functionally coupled to the inner core such that when the inner core is in a second mode, the flush supply inlet supplies fluid flow to the inner core flow path.

13. The valve of claim 12, wherein the valve inlet and outlet each include coupling structures configured to couple to ends of a fluid line, thereby allowing the valve body to be serially placed within a fluid flow system.

14. The valve of claim 13, further comprising a stop protrusion functionally coupled to the inner core, either directly or through the handle protrusion, that allows the inner core to rotate in one direction more than 90 degrees from the first mode but prevents such rotation beyond a predefined angle that is less than 180 degrees from the first mode.

15. The valve of claim 14, further comprising a bias member functionally coupled to the inner core that biases the inner core in the first mode such that when the inner core is placed into a second mode and force is released from doing so, the inner core springs back into the first mode.

16. A back-flushable fluid dispensing system, comprising:
a. a fluid supply line;
b. back-flushable filtered valve coupled to the fluid supply line, including:
i. a valve body having a valve inlet and a valve outlet,
ii. an inner core disposed within the valve body between the valve inlet and the valve outlet and rotatably coupled to an interior of the valve body, including:
1. an inner core flow path defined by a hollow region between walls within the inner core, the inner core flow path having a core inlet and a core outlet such that when the inner core is turned to a first mode fluid may thereby traverse the valve body by passing through the inner core; and
2. a filter disposed within the inner core flow path substantially blocking the inner core flow path for particulates greater than the filter sizing, the filter having a first side and a second side wherein on the first mode the first side faces fluid flow thereby trapping particulates therein;
iii. a diversion outlet spaced from the valve inlet and the valve outlet, disposed through the valve body, and functionally coupled to the inner core such that when the inner core is turned to a second mode the first side of the filter faces the diversion outlet and fluid is able to back-flow through the filter and out the diversion flow outlet; and
iv. a handle protrusion extending from the inner core through the valve body such that the inner core may be manipulated between the first mode and the second mode; and
c. a fluid dispensing head functionally coupled to the back-flushable filtered valve such that fluid from the fluid supply line may be dispensed through the fluid dispensing head after being filtered by the back-flushable filtered valve.

17. The system of claim 16, wherein the diversion outlet is functionally coupled to a container for separately holding particulate matter from the valve.

18. The system of claim 16, wherein the inner core flow path is defined by asymmetric inner core walls: a first wall that is larger than a second wall, wherein the first wall in a first mode blocks the diversion outlet and in a second mode blocks the core outlet.

19. The system of claim 18, further comprising a stop protrusion functionally coupled to the inner core, either directly or through the handle protrusion, that allows the inner core to rotate in one direction more than 90 degrees from the first mode but prevents such rotation beyond a predefined angle that is less than 180 degrees from the first mode.

20. The system of claim 19, further comprising a bias member functionally coupled to the inner core that biases the inner core in the first mode such that when the inner core is placed into a second mode and force is released from doing so, the inner core springs back into the first mode.
